(19) United States
(12) Patent Application Publication
(10) Pub. No.: US 2006/0195240 A1
(43) Pub. Date: Aug. 31, 2006

(54) Secondary suspension element for a rail vehicle

(76) Inventor: Laurent Beaubatie, Paris (FR)

Correspondence Address: CLARK & BRODY, 1090 VERMONT AVENUE, NW, SUITE 250, WASHINGTON, DC, 20005, US

(21) Appl. No.: 11/353,048

(22) Filed: Feb. 14, 2006

(30) Foreign Application Priority Data
Feb. 17, 2005 (FR) 0501644

(51) Int. Cl. B60G 17/018

(52) U.S. Cl. 701/37; 701/38

(57) ABSTRACT

The invention relates to a secondary suspension element comprising an annular membrane having its internal portion mounted on a first bead secured to a bogie and its external portion mounted to a second bead of a box that is to be secured to a railway vehicle body and comprising a resilient device of an emergency suspension secured to the body and against which the first bead comes into abutment in the event of a pressure chamber defined by the box and the membrane becoming depressurized, wherein the resilient device of the emergency suspension is mounted without mechanical prestress and presents a rigid central part and a rigid cylindrical outer part between which there is bonded a resilient element, the rigid annular outer part being secured to an end wall of the opposite from the annular membrane, the end wall of the box presenting an opening for connection to ambient air, so as to define a chamber for putting one face of the resilient device of the emergency suspension that is opposite from the pressure chamber into communication with ambient air, the resilient device of the emergency suspension having an emergency position corresponding to depressurization of the annular membrane in which the rigid central part is spaced apart from the end wall of the box and comes into abutment against the first bead; and an active position corresponding to the pressure chamber being put under a pressure, in which the rigid central part is urged by the pressure in the pressure chamber towards the end wall of the box.

The present invention relates to a secondary suspension element comprising an annular membrane for putting under pressure and an emergency suspension element enabling the train to travel, generally at low speed, in the event of depressurization.

### BACKGROUND OF THE INVENTION

With the Talgo tilting train, it is known to suspend the cars by means of inter-body pneumatic membranes on a single-axle bogie. The bottom bead of the membrane is mounted on a vertical column belonging to the bogie and forming an additional tank, and the top bead is connected to the top portion of the body. Each bogie is associated with two vertical columns and with two pneumatic membranes.

The emergency spring is an abutment mounted in parallel with the membrane and prestressed so that while the membrane is in inflated mode a sheet of air is conserved of sufficient thickness to allow dynamic and tilting movement to take place without the abutment coming into contact with the top of the column.

Such an abutment is too stiff to obtain the level of comfort required at high speed when in deflated mode, thus obliging trains of that type to run at reduced speed when in deflated mode.

It would therefore be appropriate to reduce this stiffness which is presently 2500 newtons per millimeter (N/mm) on the Talgo tilting train, e.g. down to 1200 N/mm.

For the secondary suspension elements, there are two conventional solutions:

1) series spring: this is the conventional configuration for railway secondary suspension;

2) parallel prestressed spring: this solution would be that of the present configuration but using a part that is very flexible.

In both cases, contact with the top of the column should be resilient and accept the tilt angle and the horizontal relative movement, which would lead to instabilities in inflated mode. In addition, when implementing a prestressed spring, the prestress and guide system needed under such circumstances would be mechanically complex and would lead to risks of jamming.

### OBJECTS AND SUMMARY OF THE INVENTION

The idea on which the invention is based is to do without any mechanical prestress, and to provide the prestress function in pneumatic manner using the pressure that exists in the pneumatic membrane chamber.

The invention thus provides a secondary suspension element comprising an annular membrane having its internal portion mounted on a first bead secured to a bogie and its external portion mounted to a second bead of a box that is to be secured to a railway vehicle body and comprising a resilient device of an emergency suspension secured to the body and against which the first bead comes into abutment in the event of a pressure chamber defined by the box and the membrane becoming depressurized, wherein the resilient device of the emergency suspension is mounted without mechanical prestress and presents a rigid central part and a rigid cylindrical outer part between which there is bonded a resilient element, the rigid annular outer part being secured to an end wall of the opposite from the annular membrane, the end wall of the box presenting an opening for connection to ambient air, so as to define a chamber for putting one face of the resilient device of the emergency suspension that is opposite from the pressure chamber into communication with ambient air, the resilient device of the emergency suspension having an emergency position corresponding to depressurization of the annular membrane in which the rigid central part is spaced apart from the end wall of the box and comes into abutment against the first bead; and an active position corresponding to the pressure chamber being put under a pressure, in which the rigid central part is urged by the pressure in the pressure chamber towards the end wall of the box.

The device as defined in this way presents numerous advantages:

no mechanism for providing prestress and guidance;

prestressed heights are adjusted by the characteristics of the emergency spring (dimensions and stiffness) enabling the spring to be retracted at least in part in inflated mode;

variation in the height of the body between inflated mode and deflated mode is less than that in the prior art;

there is no risk of the system jamming; and

the base makes contact between the bead and the emergency spring progressively, and the transition between inflated mode and deflated mode is likewise progressive.

The resilient element of the resilient device of the emergency suspension (or emergency spring) is preferably frustoconical, flaring towards the annular membrane, thus providing greater flexibility and where appropriate making it possible to accommodate operation in tilting mode, at least in part. Said resilient element may also be cylindrical.

### BRIEF DESCRIPTION OF THE DRAWING

Other characteristics and advantages of the invention appear better on reading the following description, given with reference to the drawing, in which:

FIG. 1 shows a preferred embodiment of a secondary suspension of the invention in inflated mode, the left-hand side showing the position of the suspension under tare weight (body empty) and the right-hand half showing the position of the suspension under full load; and

FIG. 2 shows the secondary suspension of FIG. 1 in deflated mode.

### MORE DETAILED DESCRIPTION

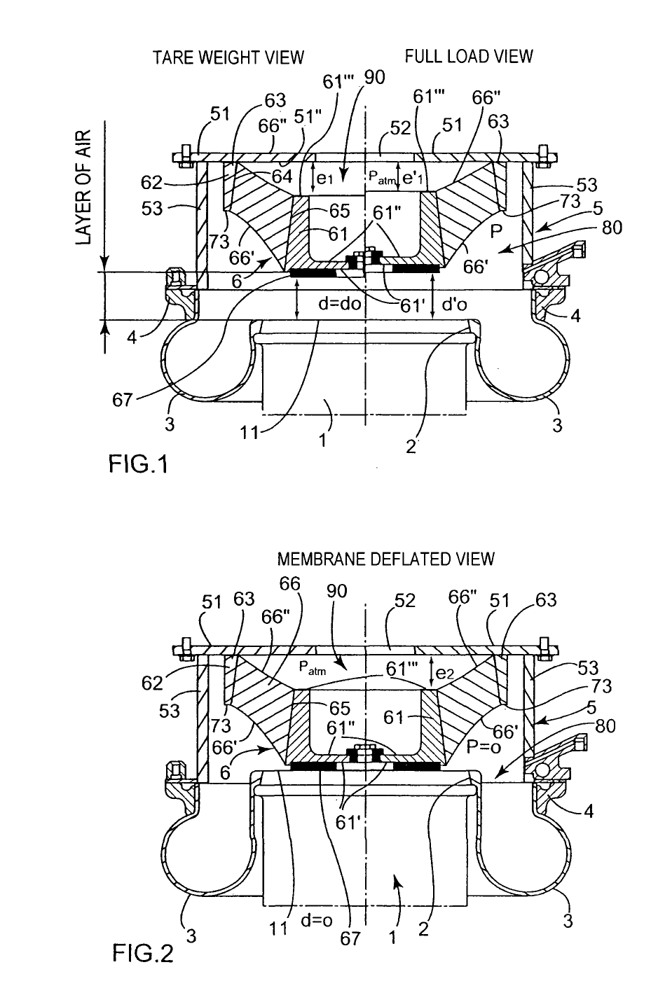

As shown in FIG. 1, the secondary suspension, represented herein by way of example by the Talgo tilting train, comprises an annular (or toroidal) membrane 3 mounted in sealed manner between a bottom bead 2 mounted at the top portion 11 of a vertical column 1 forming part of the bogie 1, and a top bead 4 mounted at the bottom of a box 5 itself secured to the body. The membrane 3 and the box 5 form a cavity 80 containing a pressure P (adjustable between 2.4 bars corresponding to force at empty tare weight, and 3.8 bars under full load for the Talgo train).

The body 5 presents a cylindrical wall 53 having mounted at its bottom end the top bead 4 and an end wall 51 in which there is formed an opening 52 for connection to ambient air.

The emergency spring presents:

a massive central part 61 on which an annular part 67 is mounted that forms an abutment for the top portion of the column 11 in deflated mode (p=0);

a cylindrical outer part 62 having a top face 63 secured in sealed manner to the end wall 52; and

an elastomer part 66 bonded at 64 and 65 to the two parts 61 and 62.

The membrane 3, the cylindrical wall 53, the face 73 of the part 62, the bottom face 66′ of the elastomer part 66, the part 67, and the bottom face 61′ of the central part 61 define the cavity 80 at pressure P.

The top face 66″ of the elastomer part 66, the top faces 61″ and 61″′ of the massive part 61, and the portion 51″ of the bottom edge of the end wall 51 that is situated inside the part 62 together define a cavity 90 for putting at atmospheric pressure via the opening 52.

In inflated mode (P lying in the range 2.4 bars to 3.8 bars), the force that results from the pressure P on the regions 66′, 67, and 61′, pushes back the rigid central part 61 towards the wall 51 at a distance e₁ therefrom (for an empty body) to a distance e′₁<e₁ at full load, thereby imparting pneumatic prestress thereto when empty or when under any load. For the Talgo train, the distance d′₀ between the top face 11 of the vertical column 1 and the abutment 67 is 74 millimeters (mm) for P=3.8 bars (full load). It is d₀=for P=2.4 bars (body empty).

In deflated mode (P=0, d=0) the pneumatic prestress disappears and the rigid central part 61 is to be found at a distance e₂ from the wall 51 which is preferably greater than the distance e₁. Changeover from inflated mode to deflated mode takes place progressively as pressure is lost, by the rigid central part 61 moving away from the wall 51. When the membrane 3 is deflated, the body moves down until the part 67 of the emergency spring comes into contact with the top of the vertical column 1. Under such circumstances, e₂ can therefore be less than or equal to e₁, but it is preferably greater.

On passing from inflated mode to deflated mode, the part 61 sinks through a stroke c which decreases the variation in body height. In the prior art (mechanical prestress) this variation was equal to at least d₀ (74 mm for the Talgo train). This sinking is now only d₀-c.

It is therefore advantageous to increase the stroke c of the part 61 between the two embodiments as much as possible.

This device presents the particularity of presenting two distinct stiffnesses:

in inflated mode, this is pressurized stiffness due to the pressure P in the cavity 80; and

in deflated mode, this is force stiffness due to the weight of the body conveyed via the vertical column 1.

By acting on the effective section on which the pressure P applies, it is possible to obtain displacement for the part 61 corresponding to tare weight under pressure P=2.4 bars in inflated mode that is greater than or equal to the displacement of the part 61 under tare weight conveyed directly by the column 1 in deflated mode.

The invention is applicable to any secondary suspension that is subject to horizontally-directed instabilities. It also applies to secondary suspensions requiring a flexible base. Under such circumstances, the emergency suspension device takes the place of the flexible base.

What is claimed is:

1. A secondary suspension element comprising an annular membrane having its internal portion mounted on a first bead secured to a bogie and its external portion mounted to a second bead of a box that is to be secured to a railway vehicle body and comprising a resilient device of an emergency suspension secured to the body and against which the first bead comes into abutment in the event of a pressure chamber defined by the box and the membrane becoming depressurized, wherein the resilient device of the emergency suspension is mounted without mechanical prestress and presents a rigid central part and a rigid cylindrical outer part between which there is bonded a resilient element, the rigid annular outer part being secured to an end wall of the opposite from the annular membrane, the end wall of the box presenting an opening for connection to ambient air, so as to define a chamber for putting one face of the resilient device of the emergency suspension that is opposite from the pressure chamber into communication with ambient air, the resilient device of the emergency suspension having an emergency position corresponding to depressurization of the annular membrane in which the rigid central part is spaced apart from the end wall of the box and comes into abutment against the first bead; and an active position corresponding to the pressure chamber being put under a pressure, in which the rigid central part is urged by the pressure in the pressure chamber towards the end wall of the box.

2. A secondary suspension element according to claim 1, wherein the resilient element is frustoconical, flaring towards the annular membrane.

3. A secondary suspension element according to claim 1, wherein the resilient element is cylindrical.

4. A secondary suspension element according to claim 1, wherein the effective section of application of the pressure is such that the displacement of the rigid central part under a tare pressure, e.g. 2.4 bars, corresponding to a tare weight in deflated mode, is greater than or equal to the displacement of the rigid central part under said tare weight conveyed directly by the first bead in deflated mode.

5. A titling railway vehicle, including at least one secondary suspension according to claim 1.
